(19) United States
(12) Patent Application Publication
(10) Pub. No.: US 2015/0047308 A1
(43) Pub. Date: Feb. 19, 2015

(54) CUTTING BLADE FOR A LAWN MOWER

(71) Applicant: Ariens Company, Brillion, WI (US)

(72) Inventor: Fredric D. Schreiner, Green Bay, WI (US)

(73) Assignee: Ariens Company, Brillion, WI (US)

(21) Appl. No.: 13/966,746

(22) Filed: Aug. 14, 2013

(51) Int. Cl. A01D 34/01

(52) U.S. Cl. CPC A01D 34/015
USPC 56/10.1; 56/289

(57) ABSTRACT

A cutting blade for a lawn mower includes a body defining an aperture for mounting the cutting blade to the lawn mower, a cutting edge formed along at least a portion of the body, and a lift portion extending from the body away from the cutting edge. The lift portion has a generally teardrop-shaped profile

### FIELD OF THE INVENTION

The present invention relates to lawn mowers and, more particularly, to cutting blades for use with lawn mowers.

### SUMMARY

In one embodiment, the invention provides a cutting blade for a lawn mower. The cutting blade includes a body defining an aperture for mounting the cutting blade to the lawn mower, a cutting edge formed along at least a portion of the body, and a lift portion extending from the body away from the cutting edge. The lift portion has a generally teardrop-shaped profile.

In another embodiment, the invention provides a cutting blade for a lawn mower. The cutting blade includes a body having a first end, a second end, and a longitudinal axis extending between the first end and the second end. The body defines an aperture for mounting the cutting blade to the lawn mower. The cutting blade also includes a first cutting edge extending from the first end along a portion of the body and a first lift portion formed at the first end of the body. The first lift portion extends from the body away from the first cutting edge. The first lift portion has an upper curved surface, a lower curved surface, and a pointed trailing edge. The cutting blade further includes a second cutting edge extending from the second end along a portion of the body and a second lift portion formed at the second end of the body. The second lift portion extends from the body away from the second cutting edge. The second lift portion has an upper curved surface, a lower curved surface, and a pointed trailing edge.

In yet another embodiment, the invention provides a lawn mower including a frame, a plurality of wheels coupled to the frame, a drive assembly supported by the frame, a cutting deck supported by the frame, and a spindle extending from the cutting deck and coupled to the drive assembly. The spindle is operable to be rotated by the drive assembly. The lawn mower also includes a cutting blade coupled to the spindle for rotation relative to the cutting deck. The cutting blade includes a body defining an aperture that receives the spindle, a cutting edge formed along at least a portion of the body, and a lift portion extending from the body away from the cutting edge. The lift portion has a generally teardrop-shaped profile.

Other aspects of the invention will become apparent by consideration of the detailed description and accompanying drawings.

### BRIEF DESCRIPTION OF THE DRAWINGS

FIG. 1 is a top perspective view of a lawn mower.

FIG. 2 is a bottom perspective of a cutting deck of the lawn mower with three cutting blades.

FIG. 3 is a top perspective view of one of the cutting blades shown in FIG. 2.

FIG. 4 is a top view of the cutting blade of FIG. 3.

FIG. 5 is a side view of the cutting blade of FIG. 3.

FIG. 6 is an end view of the cutting blade of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. In addition, the terms “upper,” “lower,” “forward,” “rearward,” etc. are used to facilitate description of the invention with reference to the drawings and a lawn mower and are not intended to be limiting.

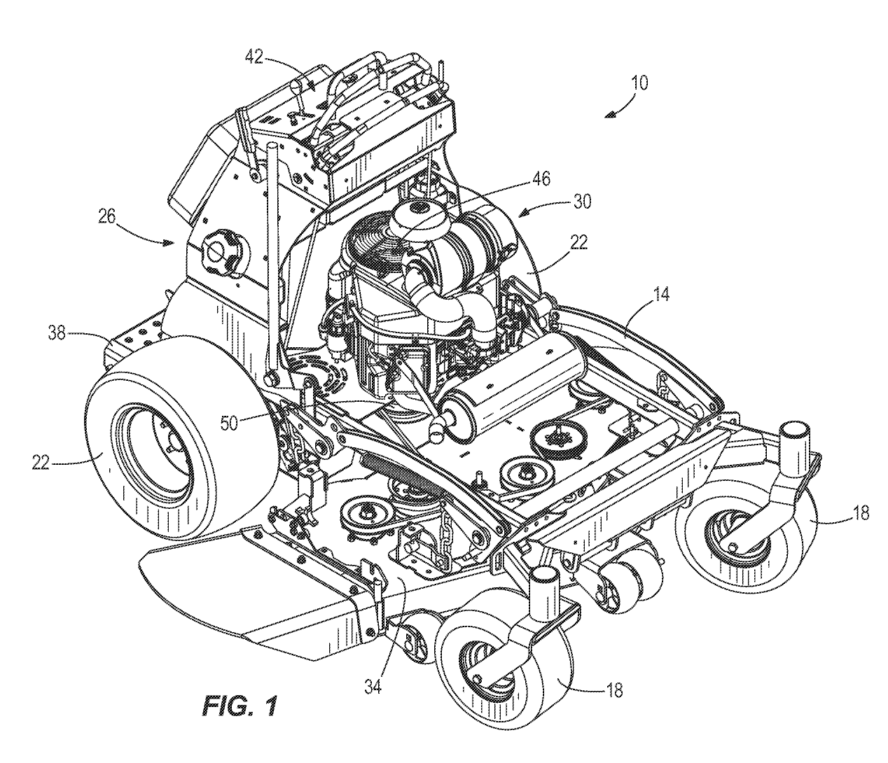

FIG. 1 illustrates a lawn mower 10. In the illustrated embodiment, the lawn mower 10 is a standing ride-on lawn mower, which is a lawn mower on which the operator stands rather than sits. In other embodiments, the lawn mower 10 may be a mid-mount, riding lawn mower or an out-front, walk behind lawn mower. The illustrated lawn mower 10 includes a frame 14, two front wheels 18 coupled to the frame 14, two rear drive wheels 22 coupled to the frame 14, an operator platform and control tower assembly 26, a mower drive assembly 30, and a cutting deck 34. The operator platform and control tower assembly 26, the mower drive assembly 30, and the cutting deck 34 are supported by the frame 14.

The illustrated front wheels 18 are passive wheels, meaning that the wheels 18 are not driven under power. In addition, the front wheels 18 are caster wheels that are mounted to the frame 14 with an arrangement that permits the wheels 18 to swivel with respect to the frame 14. Such an arrangement accommodates turning and rotating of the lawn mower 10. In some embodiments, the front wheels 18 are not passive, but instead can be actively driven and/or steered by an operator.

The rear drive wheels 22 are driven by the mower drive assembly 30. In the illustrated embodiment, the rear drive wheels 22 are capable of rotating independent of one another in forward and reverse directions to cause forward, reverse, and turning movement of the lawn mower 10. If the rear drive wheels 22 rotate in opposite directions (i.e., one forward and one reverse) at the same speed, the lawn mower 10 rotates about a zero-radius turning axis, or zero-turn or ZT axis.

The operator platform and control tower assembly 26 includes a platform 38 on which an operator stands during operation of the lawn mower 10. The assembly 26 also includes controls 42 that are accessible to an operator standing on the platform 38. The controls 42 are coupled to the mower drive assembly 30 and other components of the lawn mower 10 to control operation of the lawn mower 10. For example, the assembly 26 can include an ignition switch, a blade engagement control, a choke, an engine speed control, a height of cut selector, and the like.

The mower drive assembly 30 includes a prime mover 46 and a transmission 50. The illustrated prime mover 46 is an internal combustion engine. In other embodiments, the prime mover 46 may be an electric or hybrid motor that is at least partially powered by a battery, a fuel cell, or other suitable power source. The transmission 50 is coupled to the prime mover 46 and to the rear wheels 22 to drive the rear wheels 22. The transmission 50 is also coupled to the cutting deck 34 to cause cutting blades in the cutting deck 34 to rotate and cut grass or other vegetation.

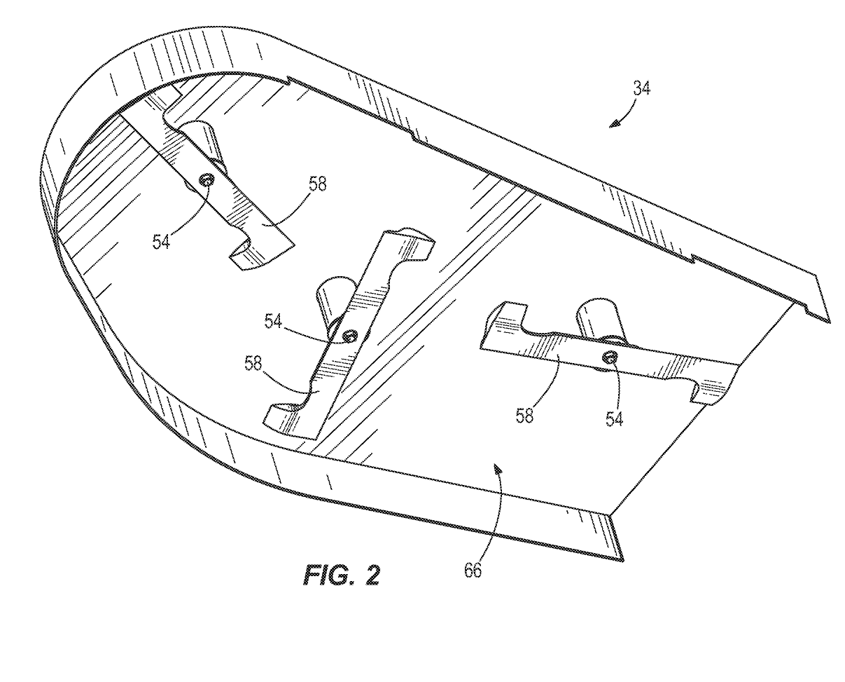

The cutting deck 34 is mounted to the frame 14 generally beneath the mower drive assembly 30 and in front of the operator platform and control tower assembly 26. As shown in FIG. 2, three spindles 54, or drive shafts, extend from the cutting deck 34 to support three cutting blades 58. The spindles 54 are coupled to the mower drive assembly 30 and operable to be rotated by the transmission 50 during operation of the lawn mower 10. The cutting deck 34 defines a cutting space 66 in which the cutting blades 58 are rotated by the spindles 54.

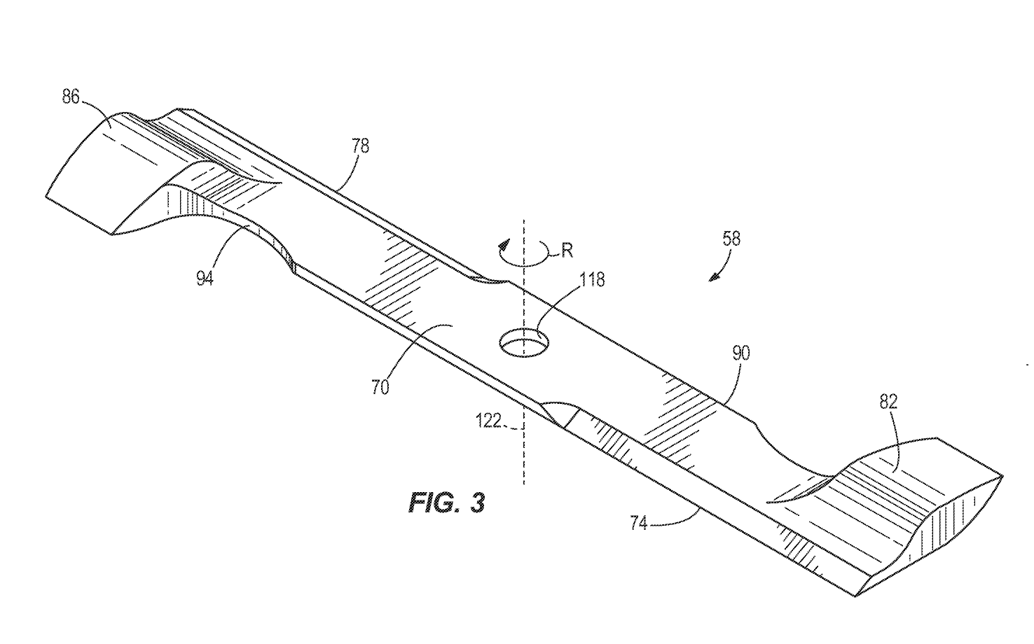

FIGS. 3-6 illustrate one of the cutting blades 58 in more detail. Although only one of the three cutting blades 58 is illustrated in detail, the other two cutting blades are substantially the same as and interchangeable with the illustrated blade 58.

The cutting blade 58 includes a body 70, two cutting edges 74, 78 formed on the body 70, two lift portions 82, 86 extending from the body 70, and two trailing edges 90, 94 formed on the body 70. The body 70, the cutting edges 74, 78, and the lift portions 82, 86 are integrally machined or formed from a single piece of material, such as stainless steel. In other embodiments, portions of the cutting blade 58 (e.g., the lift portions 82, 86) may be manufactured as separate pieces that are later welded or otherwise permanently secured to the remainder of the cutting blade 58.

The body 70 has a first end 98, a second end 102, and a longitudinal axis 106 extending between the first and second ends 98, 102. The body 70 also includes an upper surface 110 that faces the cutting deck 34 (FIG. 2) of the lawn mower 10 and a lower surface 114 that faces away from the cutting deck 34 (i.e., toward the ground). Except for areas where the cutting edges 74, 78 and the lift portions 82, 86 are located, the upper and lower surfaces 110, 114 are generally planar. The body 70 defines an aperture 118 extending through the upper and lower surfaces 110, 114 for mounting the cutting blade 58 to the lawn mower 10. The aperture 118 is shaped and sized to receive one of the spindles 54 (FIG. 2) extending from the cutting deck 34. The illustrated aperture 118 is generally located at a midpoint of the body 70 between the first and second ends 98, 102 and defines an axis of rotation 122 of the cutting blade 58.

The cutting edges 74, 78 are sharpened edges on the body 70 suitable for cutting grass or other vegetation. The illustrated cutting edges 74, 78 are defined by chamfered surfaces 126, 130 in the upper surface 110 of the body 70 such that the cutting edges 74, 78 are formed at the lower surface 114 of the body 70. The cutting edges 74, 78 are located on forward sides of the body 70 in a direction of rotation R (FIG. 3) of the cutting blade 58. The first cutting edge 74 extends from the first end 98 of the body 70 along the body 70 and is parallel to the longitudinal axis 106. The second cutting edge 78 extends from the second end 102 of the body 70 along the body 70 and is parallel to the longitudinal axis 106. The cutting edges 74, 78 extend from their respective ends 98, 102 of the body 70 toward, but not all the way to, the aperture 118 in the body 70.

The lift portions 82, 86 extend from the body 70 away from the cutting edges 74, 78. The lift portions 82, 86 are located on rearward sides of the body 70 in the direction of rotation R (FIG. 3) of the cutting blade 58. The first lift portion 82 is formed at the first end 98 of the body 70 and extends perpendicularly from the body 70 away from the first cutting edge 74. The second lift portion 86 is formed at the second end 102 of the body 70 and extends perpendicularly from the body 70 away from the second cutting edge 78. The cutting edges 74, 78 and the lift portions 82, 86 are symmetrically arranged about the axis of rotation 122 such that the cutting blade 58 is symmetrical and balanced.

The trailing edges 90, 94 are also located on the rearward sides of the body 70 in the direction of rotation R (FIG. 3) of the cutting blade 58. The first trailing edge 90 is located opposite the first cutting edge 74. The second trailing edge 94 is located opposite the second cutting edge 78. Each trailing edge 90, 94 includes three portions 134, 138, 142. The first portion 134 of each trailing edge 90, 94 is defined by the corresponding lift portion 82, 86. The second portion 138 of each trailing edge 90, 94 is spaced apart from first portion 134 and ultimately transitions into the other cutting edge 74, 78 (i.e., the second portion 138 of the first trailing edge 90 transitions into the second cutting edge 78, and the second portion 138 of the second trailing edge 94 transitions into the first cutting edge 74). The third portion 142 of each trailing edge 90, 94 is positioned between the corresponding first and second portions 134, 138. In the illustrated embodiment, the third portion 142 of each trailing edge 134, 138 is curved inwardly toward the longitudinal axis 106 of the body 70 such that the third portion 142 defines a recess or cutout 146 in the body 70. In other embodiments, the third portion 142 of each trailing edge 90, 94 may be omitted such that the second portion 138 of each trailing edge 90, 94 transitions directly into the corresponding lift portion 82, 86.

As shown in FIG. 6, each of the lift portions 82, 86 has a generally teardrop-shaped profile. That is, the lift portions 82, 86 are generally teardrop in shape when the cutting blade 58 is viewed along the longitudinal axis 106 of the body 70 from either the first end 98 (as viewed in FIG. 6) or the second end 102. The teardrop-shaped profile is defined by an upper curved surface 150 and a lower curved surface 154 of each lift portion 82, 86. The upper curved surface 150 is the surface of each lift portion 82, 86 that faces the cutting deck 34 (FIG. 2). The lower curved surface 154 is the surface of each lift portion 82, 86 that faces away from the cutting deck 34 (i.e., toward the ground).

The teardrop-shaped profile of each lift portion 82, 86 is also defined by a bulbous proximal end 158 and a tapered distal end 162. The proximal end 158 is adjacent or near the corresponding cutting edge 74, 78 (i.e., upstream in the direction of rotation R (FIG. 3) of the cutting blade 58). The distal end 162 is spaced away from the corresponding cutting edge 74, 78 (i.e., downstream in the direction of rotation R (FIG. 3) of the cutting blade 58). The upper and lower surfaces 150, 154 of each lift portion 82, 86 curve toward each other to form the tapered distal end 162. That is, in contrast to standard airfoil designs where one surface is rounded and one surface is planar or slightly concave, both of the illustrated upper and lower surfaces 150, 154 are curved and convex to create the teardrop-shaped profile of each lift portion 82, 86.

The illustrated first and second lift portions 82, 86 of the cutting blade 58 are similarly shaped and sized. As such, only the first lift portion 82 is described in more detail below. The description of features and elements of the first lift portion 82 also apply to the second lift portion 86.

With continued reference to FIG. 6, the upper surface 150 of the first lift portion 82 has a first average radius of curvature, and the lower surface 154 of the first lift portion 82 has a second average radius of curvature. The average radius of curvature is the average amount of curvature of a surface. The amount of curvature of the illustrated upper and lower surfaces 150, 154 varies between the proximal and distal ends 158, 162 of the lift portion 82. For example, the illustrated upper surface 150 has a relatively large curvature near the proximal end 158 of the lift portion 82, but has a relatively small curvature near the distal end 162 of the lift portion 82. In contrast, the illustrated lower surface 154 includes a planar portion 166 near the proximal end 158 of the lift portion 82 and a relatively small curvature near the distal end 162 of the lift portion 82. In other embodiments, the radius of curvature of one or both of the surfaces 150, 154 may be constant such that the average radius of curvature is the only radius of curvature. In the illustrated embodiment, the average radius of curvature of the upper surface 150 is greater than the average radius of curvature of the lower surface 154. In other embodiments, the average radius of curvature of the lower surface 154 may be greater than the average radius of curvature of the upper surface 150, or the average radii of curvature of the upper and lower surfaces 150, 154 may be substantially equal.

The upper and lower surfaces 150, 154 come together at the distal end 162 of the first lift portion 82 to define the first portion 134 of the trailing edge 90. In the illustrated embodiment, the first portion 134 of the trailing edge 90 is pointed. In other embodiments, the first portion 134 of the trailing edge 90 may be rounded or flat. Due to the curvature of the lower surface 154, the first portion 134 of the trailing edge 90 is positioned higher (i.e., closer to the cutting deck 34 (FIG. 2)) than the first cutting edge 74. In particular, the first portion 134 of the trailing edge 90 is spaced apart from the lower surface 114 of the body 70 in a direction parallel to the axis of rotation 122 of the cutting blade 58. In the illustrated embodiment, the first portion 134 of the trailing edge 90 is spaced further apart from the lower surface 114 of the body 70 in the direction parallel to the axis of rotation 122 of the cutting blade 58 than the upper surface 110 of the body 70. In other words, as shown in FIG. 6, the first portion 134 of the trailing edge 90 is positioned above a plane 170 defined by the upper surface 110 of the body 70 such that the first portion 134 of the trailing edge 90 is closer to the cutting deck 34 (FIG. 2) of the lawn mower 10 than the upper surface 110.

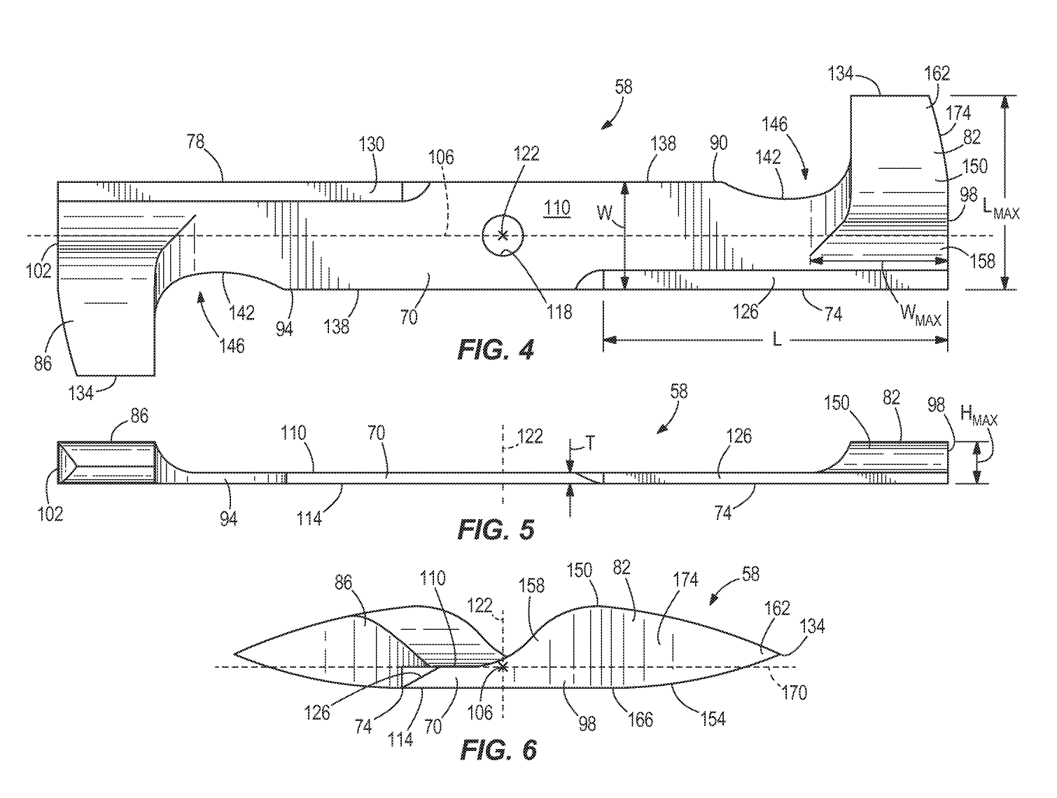

As shown in FIG. 4, the body 70 has a width W measured perpendicular to the longitudinal axis 106 between the first cutting edge 74 and the second portion 138 of the first trailing edge 90. Similarly, the first lift portion 82 has a maximum length Lₘₐₓ measured perpendicular to the longitudinal axis 106 between the first cutting edge 74 and the first portion 134 of the trailing edge 90. The maximum length Lₘₐₓ of the lift portion 82 is greater than the width W of the body 70 such that the first portion 134 of the trailing edge 90 is spaced further from the longitudinal axis 106 than the second portion 138 of the trailing edge 90. In some embodiments, the maximum length Lₘₐₓ of the lift portion 82 may be at least fifty percent longer than the width W of the body 70. In the illustrated embodiment, the maximum length Lₘₐₓ of the lift portion 82 is about eighty percent longer than the width W of the body 70.

As shown in FIG. 5, the body 70 has a thickness T measured between the upper surface 110 and the lower surface 114 of the body 70. Similarly, the first lift portion 82 has a maximum height Hₘₐₓ, or thickness, measured between the upper surface 150 and the lower surface 154 of the lift portion 82. The maximum height Hₘₐₓ is measured at a thickest portion of the teardrop-shaped profile near the proximal end 158 of the lift portion 82. The maximum height Hₘₐₓ of the lift portion 82 is greater than the thickness T of the body 70 such that the upper surface 150 of the lift portion 82 is positioned closer to the cutting deck 34 (FIG. 2) than the upper surface 110 of the body 70. In some embodiments, the maximum height Hₘₐₓ of the lift portion 82 may be at least twice as large as the thickness T of the body 70. In the illustrated embodiment, the maximum height Hₘₐₓ of the lift portion 82 is about four times the thickness T of the body 70.

As shown in FIG. 4, the first cutting edge 74 has a length L measured parallel to the longitudinal axis 106 of the body 70. Similarly, the first lift portion 82 has a maximum width Wₘₐₓ measured parallel to the longitudinal axis 106. The maximum width Wₘₐₓ is measured through a section of the lift portion 82 where the lift portion 82 is widest. In the illustrated embodiment, an end surface 174 of the lift portion 82 tapers axially inwardly from the proximal end 158 to the distal end 162, thereby reducing the width of the lift portion 82 along its length. The maximum width Wₘₐₓ of the lift portion 82 is smaller than the length L of the cutting edge 74. In some embodiments, the maximum width Wₘₐₓ of the lift portion 82 may be less than half of the length L of the cutting edge 74. In the illustrated embodiment, the maximum width Wₘₐₓ of the lift portion 82 is about forty percent of the length L of the cutting edge 74. In other embodiments, the maximum width Wₘₐₓ of the lift portion 82 may be generally equal to the length L of the cutting edge 74.

The teardrop-shaped profiles of the lift portions 82, 86 reduce the pressure drag, or wake, behind the cutting blade 58 as the cutting blade 58 rotates. In particular, the lift portions 82, 86 are configured to keep air that moves over the cutting blade 58 attached to the surfaces of the cutting blade 58 longer than blades without teardrop-shaped lift portions. The longer the air remains attached to the surfaces of the cutting blade 58, the lower the pressure drag of the cutting blade 58. By reducing pressure drag, the amount of power required to rotate the cutting blade 58 is also reduced. As such, the amount of power (e.g., fuel or energy) required to rotate the cutting blade 58 at given speed is reduced, increasing the efficiency of the lawn mower 10.

Various features and advantages of the invention are set forth in the following claims.

What is claimed is:

1. A cutting blade for a lawn mower, the cutting blade comprising:
a body defining an aperture for mounting the cutting blade to the lawn mower;
a cutting edge formed along at least a portion of the body; and
a lift portion extending from the body away from the cutting edge, the lift portion having a generally teardrop-shaped profile.

2. The cutting blade of claim 1, wherein the lift portion has an upper surface and a lower surface, wherein the upper surface has a first average radius of curvature, wherein the lower surface has a second average radius of curvature, and wherein the first average radius of curvature is greater than the second average radius of curvature.

3. The cutting blade of claim 2, wherein a portion of the lower surface is planar.

4. The cutting blade of claim 1, further comprising a trailing edge located on an opposite side of the body from the cutting edge, wherein the lift portion defines at least a portion of the trailing edge.

5. The cutting blade of claim 4, wherein the at least a portion of the trailing edge defined by the lift portion is pointed.

6. The cutting blade of claim 4, wherein the trailing edge includes a first portion defined by the lift portion and a second portion defined by the body.

7. The cutting blade of claim 6, wherein the body has a longitudinal axis, wherein the first portion of the trailing edge is spaced further from the longitudinal axis than the second portion of the trailing edge.

8. The cutting blade of claim 7, wherein the body has a width measured perpendicular to the longitudinal axis between the cutting edge and the second portion of the trailing edge, wherein the lift portion has a maximum length measured perpendicular to the longitudinal axis between the cutting edge and the first portion of the trailing edge, and wherein the maximum length of the lift portion is at least fifty percent longer than the width of the body.

9. The cutting blade of claim 6, wherein the trailing edge includes a third portion positioned between the first portion and the second portion, and wherein the third portion of the trailing edge is curved.

10. The cutting blade of claim 4, wherein the body has an upper surface and a lower surface, wherein the aperture in the body defines an axis of rotation of the cutting blade, wherein the cutting edge is partially formed at the lower surface of the body, and wherein the first portion of the trailing edge is spaced from the lower surface of the body in a direction parallel to the axis of rotation.

11. The cutting blade of claim 10, wherein the first portion of the trailing edge is spaced further from the lower surface of the body in the direction parallel to the axis of rotation than the upper surface of the body.

12. The cutting blade of claim 1, wherein the body has an upper surface, a lower surface, and a thickness measured between the upper and lower surfaces of the body, wherein the lift portion has an upper surface, a lower surface, and a maximum height measured between the upper and lower surfaces of the lift portion at a thickest portion of the generally teardrop-shaped profile, and wherein the maximum height of the lift portion is greater than the thickness of the body.

13. The cutting blade of claim 12, wherein the maximum height of the lift portion is at least twice as large as the thickness of the body.

14. The cutting blade of claim 1, wherein the body has a first end and a second end, wherein the aperture is defined generally at a midpoint of the body between the first and second ends, wherein the cutting edge extends from the first end of the body toward the aperture, and wherein the lift portion is formed at the first end of the body.

15. The cutting blade of claim 14, wherein the body has a longitudinal axis extending between the first and second ends of the body, wherein the cutting edge has a length measured parallel to the longitudinal axis, wherein the lift portion has a maximum width measured parallel to the longitudinal axis, and wherein the maximum width of the lift portion is less than half of the length of the cutting edge.

16. The cutting blade of claim 1, wherein the aperture in the body defines an axis of rotation of the cutting blade, wherein the cutting edge is a first cutting edge and the lift portion is a first lift portion, and further comprising:
a second cutting edge formed along at least a portion of the body, and
a second lift portion extending from the body opposite the second cutting edge, the second lift portion having a generally teardrop-shaped profile,
wherein the first and second cutting edges and the first and second lift portions are symmetrically arranged about the axis of rotation.

17. A cutting blade for a lawn mower, the cutting blade comprising:
a body having a first end, a second end, and a longitudinal axis extending between the first end and the second end, the body defining an aperture for mounting the cutting blade to the lawn mower;
a first cutting edge extending from the first end along a portion of the body;
a first lift portion formed at the first end of the body, the first lift portion extending from the body away from the first cutting edge, the first lift portion having an upper curved surface, a lower curved surface, and a pointed trailing edge;
a second cutting edge extending from the second end along a portion of the body; and
a second lift portion formed at the second end of the body, the second lift portion extending from the body away from the second cutting edge, the second lift portion having an upper curved surface, a lower curved surface, and a pointed trailing edge.

18. The cutting blade of claim 17, wherein the upper curved surface of each lift portion has a first average radius of curvature, wherein the lower curved surface of each lift portion has a second average radius of curvature, and wherein the first average radius of curvature is greater than the second average radius of curvature.

19. The cutting blade of claim 17, wherein the body has a width measured perpendicular to the longitudinal axis, wherein each lift portion has a maximum length measured perpendicular to the longitudinal axis, and wherein the maximum length is greater than the width.

20. The cutting blade of claim 17, wherein the body has a thickness, wherein each lift portion has a maximum height measured between the corresponding upper and lower curved surfaces, and wherein the maximum height is larger than the thickness.

21. The cutting blade of claim 17, wherein each cutting edge has a length measured parallel to the longitudinal axis, wherein each lift portion has a maximum width measured parallel to the longitudinal axis, and wherein the maximum width is less than half of the length.

22. A lawn mower comprising:
a frame;
a plurality of wheels coupled to the frame;
a drive assembly supported by the frame;
a cutting deck supported by the frame;
a spindle extending from the cutting deck and coupled to the drive assembly, the spindle operable to be rotated by the drive assembly; and
a cutting blade coupled to the spindle for rotation relative to the cutting deck, the cutting blade including
a body defining an aperture that receives the spindle,
a cutting edge formed along at least a portion of the body, and
a lift portion extending from the body away from the cutting edge, the lift portion having a generally teardrop-shaped profile.

23. The lawn mower of claim 22, wherein the lift portion includes an upper surface and a lower surface, wherein the upper surface of the lift portion has a first average radius of curvature, wherein the lower surface of the lift portion has a second average radius of curvature, and wherein the first average radius of curvature is greater than the second average radius of curvature.

24. The lawn mower of claim 22, wherein the cutting blade further includes a trailing edge located on an opposite side of the body from the cutting edge, wherein the lift portion of the cutting blade defines at least a portion of the trailing edge, and wherein the at least a portion of the trailing edge defined by the lift portion is pointed.

25. The lawn mower of claim 22, wherein the body of the cutting blade has a longitudinal axis and a width measured perpendicular to the longitudinal axis, wherein the lift portion of the cutting blade has a maximum length measured perpendicular to the longitudinal axis, and wherein the maximum length is greater than the width.

26. The lawn mower of claim 22, wherein the body of the cutting blade has a thickness, wherein the lift portion of the cutting blade has an upper surface, a lower surface, and a maximum height measured between the upper and lower surfaces, and wherein the maximum height is greater than the thickness.

27. The lawn mower of claim 22, wherein the body of the cutting blade has a longitudinal axis, wherein the cutting edge of the cutting blade has a length measured parallel to the longitudinal axis, wherein the lift portion of the cutting blade has a maximum width measured parallel to the longitudinal axis, and wherein the maximum width is less than half of the length.
